(19) United States
(12) Patent Application Publication
(10) Pub. No.: US 2003/0072233 A1
(43) Pub. Date: Apr. 17, 2003

(54) Optical disk player

(76) Inventors: Hiroki Naoi, Nagano (JP); Hiroyuki Nakamura, Nagano (JP); Wataru Mashima, Nagano (JP)

Correspondence Address: BIRCH STEWART KOLASCH & BIRCH, PO BOX 747, FALLS CHURCH, VA, 22040-0747, US

(21) Appl. No.: 10/270,604

(22) Filed: Oct. 16, 2002

(30) Foreign Application Priority Data
Oct. 16, 2001 (JP) 2001-317874
Mar. 1, 2002 (JP) 2002-055463

(51) Int. Cl. G11B 7/125

(52) U.S. Cl. 369/47.53; 369/53.27

(57) ABSTRACT

The optical disk player is capable of writing data with optimum laser power corresponding to temperature. In the optical disk player, a laser diode irradiates a laser beam. A photo sensor detects light intensity of a reflected beam reflected from an optical disk. A processor controls laser power of the laser diode by a running optimum power control manner, in which the laser power is adjusted, on the basis of the detected light intensity of the reflected beam, to optimum laser power. A memory stores power correction values for correcting the laser power as a data table, in which the power correction values have been determined on the basis of temperature. The processor retrieves the power correction value from the memory and adds the retrieved power correction value to the present laser power of the laser diode in the case of increasing the laser power.

### BACKGROUND OF THE INVENTION

The present invention relates to an optical disk player, more precisely relates to an optical disk player capable of writing data on an optical disk, e.g., CD-R, CD-RW, DVD-R, DVD-RAM.

To write data on optical disks, optical disk players, e.g., a CD-R player, a CD-RW player, a DVD-R player, a DVD-RAM player, have been used.

In the optical disk player, a data writing test or an optimum power control (OPC) test is executed in a power calibration area (PCA), which is located in an innermost part of a recording face of the optical disk, when data are written on the optical disk so as to adjust laser power for writing data to optimum power.

A method of setting the laser power of the optical disk will be explained.

Firstly, the optical disk player reads an absolute time in pregroove (ATIP) from the optical disk. A manufacturer of the optical disk has previously written data of the optical disk in the ATIP.

The optical disk player reads the data of the disk, e.g., the name of the manufacturer, a type of the optical disk, from the ATIP, then retrieves recommended laser power of the disk from a data table on the basis of the data. The data table has been previously stored in the optical disk player.

The optical disk player executes the OPC test with increasing and decreasing the laser power with respect to the recommended laser power. The written test data are read so as to check up-down symmetry of waveforms of light intensity of reflected laser beams. The laser power whose up-down symmetry is the best of all is selected and set as the optimum laser power of the disk.

The optical disk player writes data with the optimum laser power determined by the OPC test.

However, characteristics of the optical disk are different in an inner part and an outer part thereof. Even if the optimum laser power is determined by the OPC test in the PCA located in the innermost part of the optical disk, the determined power is not optimum in the outer part thereof.

To adjust the laser power, light intensity of the reflected laser beam is measured while writing data, and the laser power is adjusted on the basis of the measured light intensity. This manner is called a running optimum power control (ROPC) manner.

The ROPC manner will be explained with reference to FIG. 6.

In FIG. 6, the axis of abscissas is time for writing data on an optical disk; the axis of ordinates is the laser power for writing data.

In the ROPC manner, the laser power is gradually increased on the basis of variation of a reflected beam from the optical disk. As shown in FIG. 6, the laser power is linearly increased, but the laser power is actually increased like steps.

Namely, the light intensity of the reflected beam reflected from the optical disk is always measured. When reduction of the light intensity is greater than prescribed value, the optical disk player judges that the laser power is insufficient, so that the laser power is increased by adding a fixed power correction value “α” to the present laser power.

By executing the ROPC, data can be written from the inner part to the outer part of the optical disk with the laser power near the optimum power.

However, in the case that the laser diode is overheated by self-heating, etc. and its temperature is higher than prescribed temperature (HIGH TEMPERATURE), actual laser power of the laser diode is smaller than preset laser power. On the other hand, in the case that the laser diode is overcooled by temperature around the laser diode, etc. and its temperature is lower than prescribed temperature (LOW TEMPERATURE), actual laser power of the laser diode is greater than the preset laser power.

As shown by dotted lines in FIG. 6, in the case of HIGH TEMPERATURE, even if the optical disk player add the power correction value “α” to the present laser power, actual increase of the laser power is less than “α”. While data are written from the inner part to the outer part of the optical disk, the actual increase less than “α” is added many times. In general, data are written with laser power much smaller than the optimum laser power.

On the other hand, in the case of LOW TEMPERATURE, even if the optical disk player add the power correction value “α” to the present laser power, actual increase of the laser power is greater than “α”. While data are written from the inner part to the outer part of the optical disk, the actual increase greater than “60 ” is added many times. In general, data are written with laser power much greater than the optimum laser power.

Namely, actual laser power is much influenced by temperature, so it is difficult to maintain the optimum laser power while writing data on the optical disk. Further, quality and reliability of written data must be low.

### SUMMARY OF THE INVENTION

An object of the present invention is to provide an optical disk player capable of writing data with optimum laser power corresponding to temperature.

To achieve the object, the optical disk player of the present invention comprises:

a laser diode for irradiating a laser beam;

a photo sensor for detecting light intensity of a reflected beam, which is the laser beam reflected from an optical disk, while writing data on the optical disk;

means for controlling laser power of the laser diode by a running optimum power control manner, in which the laser power is adjusted, on the basis of the detected light intensity of the reflected beam while writing data on the optical disk, to optimum laser power; and

means for storing a plurality of power correction values for correcting the laser power for writing data to the optimum laser power as a data table, in which the power correction values have been determined on the basis of types of the optical disk and temperature,

wherein the control means retrieves the power correction value from the storing means and adds the retrieved power correction value to the present laser power of the laser diode in the case of increasing the laser power while writing data.

With this structure, in the case of adding the power correction value to the present laser power, the power correction value corresponding to the temperature can be selected, so that data can be written the optimum laser power. Therefore, quality and reliability of the written data can be improved.

In the optical disk player, the control means may determine the temperature on the basis of a waveform of the light intensity of the reflected beam during the optimum power control action, retrieve the power correction value from the storing means on the basis of the type of the optical disk and the temperature, and vary the laser power of the laser diode by the retrieved power correction value when the laser power is adjusted.

With this structure, the temperature can be precisely known, so that the optimum laser power for writing data can be correctly selected. Therefore, quality and reliability of the written data can be improved.

The optical disk player may further comprise a thermo sensor for detecting temperature around the laser diode, and

the control means may retrieve the power correction value from the storing means on the basis of the type of the optical disk and the temperature detected by the thermo sensor, and vary the laser power of the laser diode by the retrieved power correction value.

With this structure, the temperature can be further precisely known, so that the quality and reliability of the written data can be further improved.

Note that, in the optical disk player, the thermo sensor may be a thermistor.

### BRIEF DESCRIPTION OF THE DRAWINGS

Embodiments of the present invention will now be described by way of examples and with reference to the accompanying drawings, in which:

FIG. 1 is a block diagram of an optical disk player of a first embodiment of the present invention;

FIG. 2 is a graph for detecting temperature of the optical disk player;

FIG. 3 is a flow chart showing action of the optical disk player of the first embodiment;

FIG. 4 is a block diagram of an optical disk player of a second embodiment of the present invention;

FIG. 5 is a flow chart showing action of the optical disk player of the second embodiment; and

FIG. 6 is a graph showing variation of laser power in a running optimum power control.

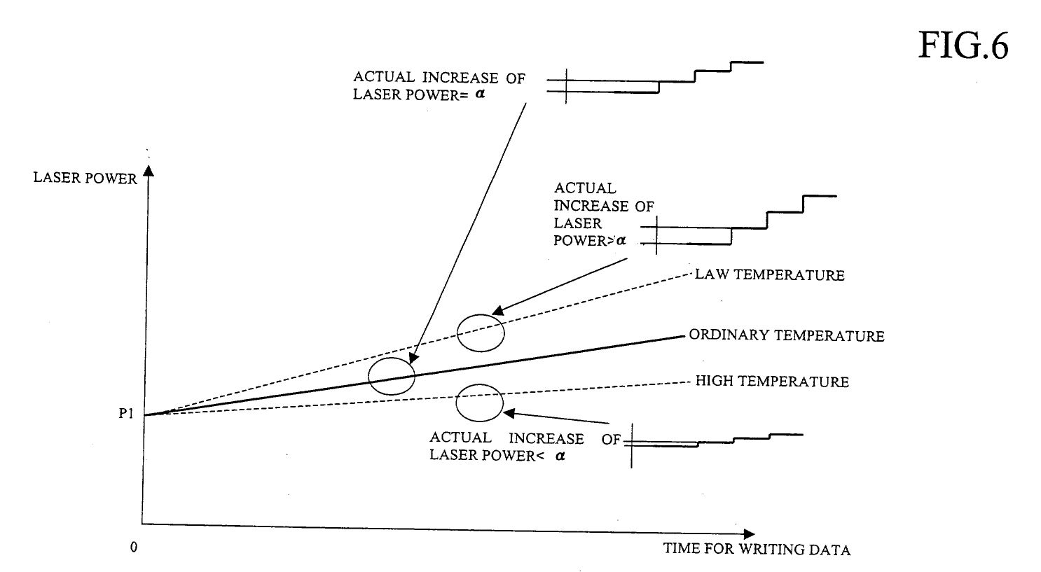

### DETAILED DESCRIPTION OF THE EMBODIMENTS

Preferred embodiments of the present invention will now be described in detail with reference to the accompanying drawings.

(First Embodiment)

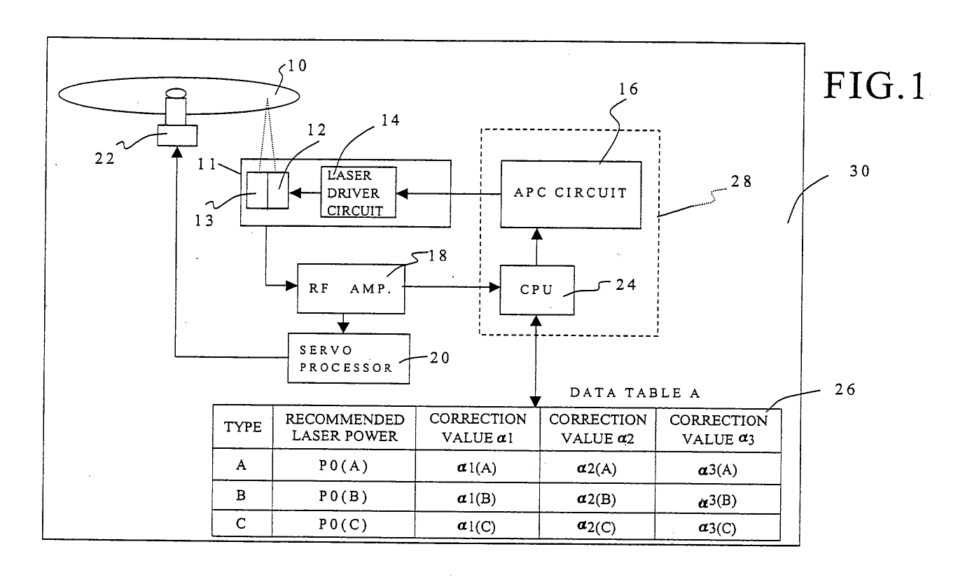

A first embodiment will be explained with reference to FIGS. 1-3.

An optical disk player 30 includes: a laser diode 12 irradiating a laser beam to an optical disk 10; a laser driver circuit 14 supplying electric current to the laser diode 12; and an auto power control (APC) circuit 16 adjusting electric voltage inputted to the laser driver circuit 14.

The laser diode 12 and the laser driver circuit 14 are built in an optical pick-up 11 and moved from an inner part to an outer part of the optical disk 10, together with the optical pick-up 11, so as to write data on the optical disk 10. Laser power of the laser diode 12 is controlled by adjusting current intensity of the electric current passing through the laser diode 12. The current intensity is adjusted by the laser driver circuit 14.

The APC circuit 16 is connected to the laser driver circuit 14. The APC circuit 16 adjusts the electric voltage inputted to the laser driver circuit 14 so as to maintain prescribed laser power.

A reflected beam reflected from the optical disk 10 is received by a photo sensor 13 built in the optical pick-up 11. The photo sensor 13 outputs signals corresponding to signals included in the reflected beam. The output signals of the photo sensor 13 are sent to and amplified in an RF amplifier 18.

The signals amplified by the RF amplifier 18 are sent to a servo processor 20. The servo processor 20 servo-controls rotation of a spindle motor 22, focusing and tracking of the optical pick-up 11, etc. on the basis of the signals.

The signals amplified by the RF amplifier 18 are sent to a CPU 24. The CPU 24 always monitors level of the signals and controls the APC circuit 16 so as to increase the laser power when data are written on the optical disk 10. For example, when the CPU 24 detects that light intensity of the reflected beam is reduced prescribed value from standard intensity, the CPU 24 reads a power correction value from a data table stored in storing means 26 and controls the APC circuit 16 so as to add the power correction value to the present laser power. With this action, the laser power of the laser diode 12 can be increased.

Action of the CPU 24 is based on control programs previously stored in a memory unit (not shown) as firm wares.

Namely, control means 28 includes the APC circuit 16 and the CPU 24.

Note that, the storing means 26, e.g., ROM, is connected to the CPU 24. The data table stored in the storing means 26 includes types of disks, recommended laser power for the OPC test, the power correction values, etc . . .

Contents of the data table will be explained.

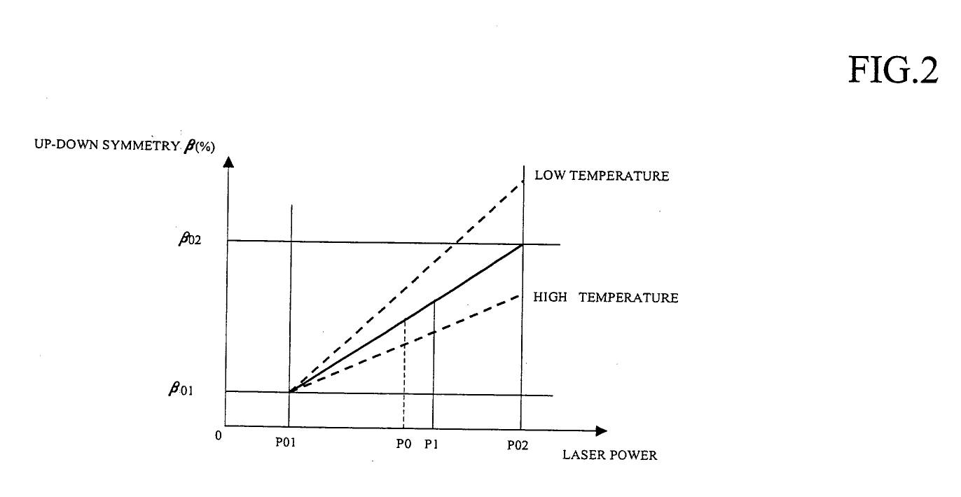

The data table was prepared in a factory before shipment. The data table includes recommended laser power P0 corresponding to types of optical disks “A, B, C . . . ” The recommended power P0 is optimum laser power for the OPC test. Actually, writing data is not started with the laser power P0. The OPC test has been explained in BACKGROUND OF THE INVENTION, so explanation will be omitted. Note that, in the OPC test, the laser power P0 is used as a standard power, and laser power P1 is defined as initial laser power for writing data (see FIG. 2).

Note that, the recommended laser power P0 depends on manufactures of optical disks, characteristics of optical disks, etc . . .

Three power correction values α1, α2 and α3 are previously prepared foe each type of optical disk. The values α1, α2 and α3 respectively correspond to low temperature, ordinary temperature and high temperature.

Number of the correction values for each type of optical disk are not limited to three. It may be four or more to correspond many temperature stages. Further, the power correction values may be prepared for not only the temperature stages but also detected temperature.

In the data table, the power correction values α1, α2 and α3 of each type “A, B, C . . . ” depend on manufactures of optical disks, characteristics of optical disks, etc . . .

Setting the power correction values will be explained with reference to FIG. 2.

While the OPC test, the laser power of the laser diode is varied, between P01 and P02 with respect to the standard power P0, and degree of up-down symmetry “β” of the waveform of the reflected beam is measured.

In the present embodiment, temperature is detected when the initial laser power P1 is determined in the OPC test. The temperature is measured by detecting variation of the up-down symmetry “β”. Namely, the temperature is known from inclination of graph shown in FIG. 2.

The inclination of the graph of low temperature is greater than that of ordinary temperature; the inclination of the graph of high temperature is smaller than that of ordinary temperature. These characteristics have been previously known. Therefore, in the present embodiment, the temperature is detected by measuring the variation of the up-down symmetry “β”, which is caused by varying the laser power during the OPC test.

The inclination “k” can be known by following formula:

k=(β02−β01)/(P02−P01)

Note that, the variation of the up-down symmetry “β” is from β01 to β02.

Then, the inclination “k” is compared with comparative values “x” and “y”. The comparative values “x” and “y” have been previously stored in a memory.

In the case of k>y, the temperature is judged as the low temperature; in the case of x<k<y, the temperature is judged as the ordinary temperature; and in the case of k<x, the temperature is judged as the high temperature.

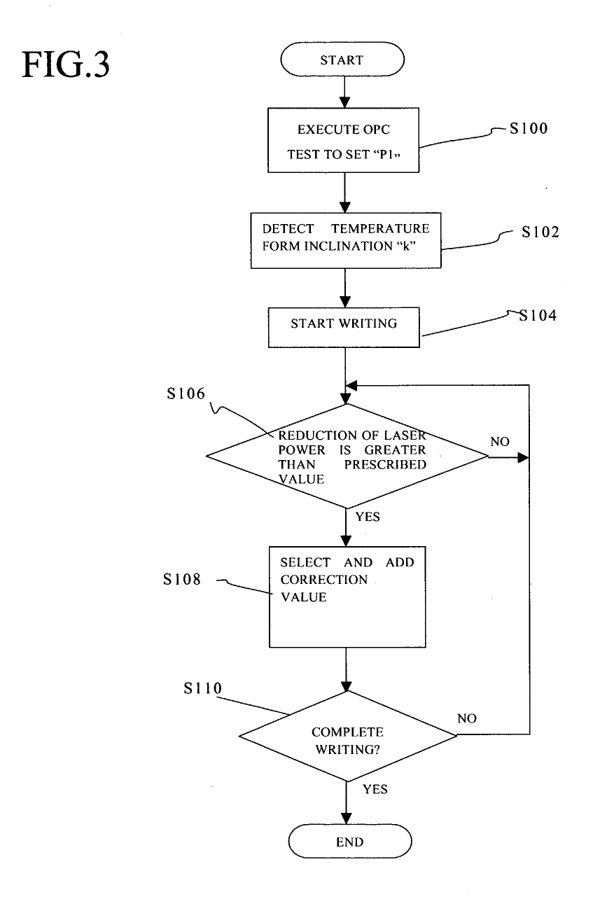

Successively, control of the optical disk player 30 will be explained with reference to a flow chart of FIG. 3.

Firstly, at a step S100, the CPU 24 reads data, e.g., the type of optical disk, recorded in an ATIP of the optical disk 10 by the optical puck-up 11, when the optical disk 10 is set to write data thereon. The data in the ATIP were written by a manufacturer before shipment.

The CPU 24 retrieves the recommended laser power P0 corresponding to the type of the optical disk 10 from the data table.

The CPU 24 executes the OPC test with the recommended laser power P0 and determines the initial laser power P1 for starting to write data on the optical disk 10.

At a step S102, the CPU 24 measures the inclination “k”, which is known from the variation of the up-down symmetry caused by varying the laser power.

The CPU 24 compares the inclination “k” with the comparative values “x” and “y” so as to detect the temperature stage. At the step S102, if k>y, the temperature is judged as the low temperature; if x<k<y, the temperature is judged as the ordinary temperature; and if k<x, the temperature is judged as the high temperature.

At a step S104, the CPU 24 starts to write data with the laser power P1.

At a step S106, if the CPU 24, which always monitors the light intensity of the reflected beam, judges that reduction of the light intensity of the reflected beam is greater than a prescribed value, the CPU 24 goes to a step S108. On the other hand, if the reduction of the light intensity is smaller than the prescribed value, the CPU 24 writes data with the present laser power.

At the step S108, the CPU 24 retrieves the power correction value corresponding to the type of the optical disk 10 from the data table. If the temperature stage judged at the step S102 is the low temperature, the CPU 24 selects the correction value α1; if the temperature stage judged at the step S102 is the ordinary temperature, the CPU 24 selects the correction value α2; if the temperature stage judged at the step S102 is the high temperature, the CPU 24 selects the correction value 60 3.

The CPU 24 controls the APC circuit 16 to add the selected correction value α1, α2 or α3 to the present laser power.

At a step S110, writing data is completed if all data have been written on the optical disk 10.

(Second Embodiment)

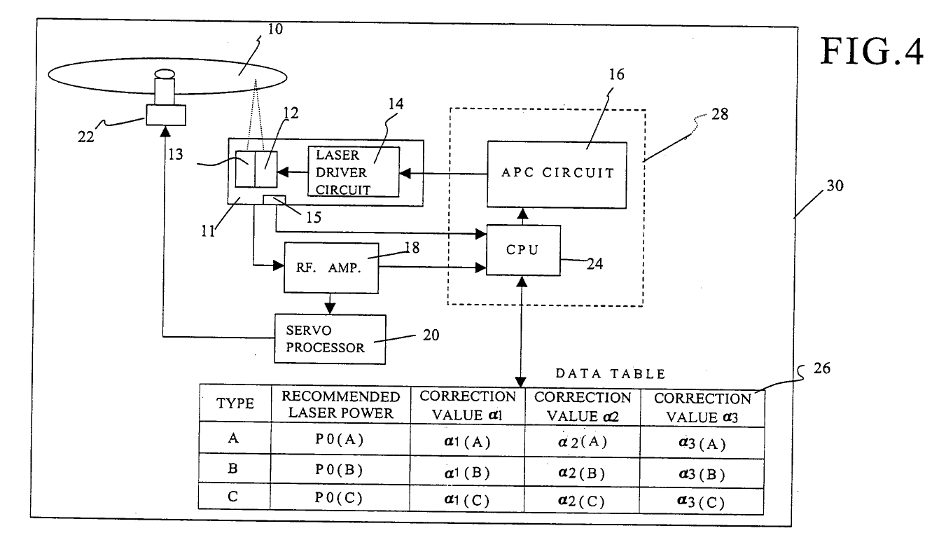

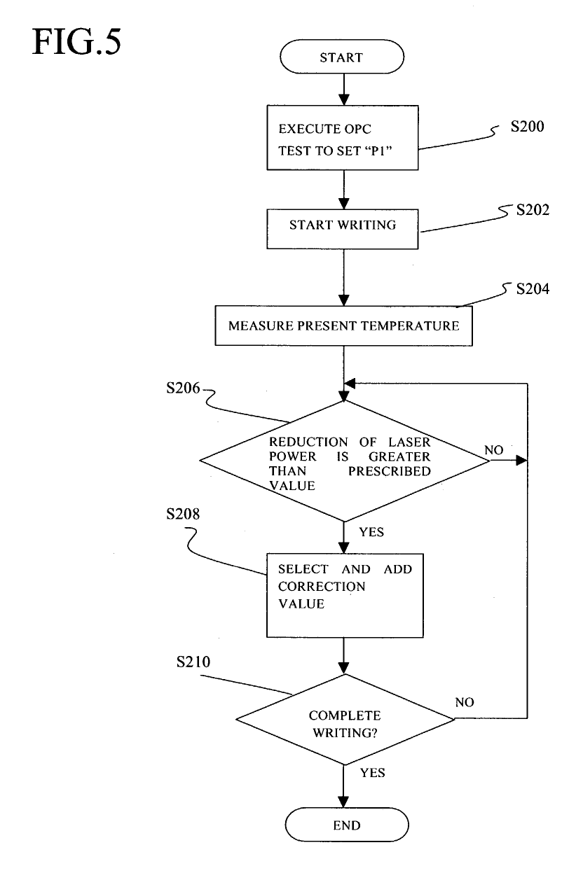

A second embodiment will be explained with reference to FIGS. 4 and 5. Note that, the elements described in the first embodiment are assigned the same symbols, and explanation will be omitted.

The feature of the second embodiment is a thermo sensor 15 which real-timely measures the present temperature around the laser diode 12.

FIG. 4 is a block diagram of the optical disk player 30.

A thermistor 15, which is an example of the thermo sensor, is provided near the laser diode 12 in the optical pick-up 11. Note that, the thermo sensor 15 is not limited to the thermistor.

The thermo sensor 15 measures the temperature around the laser diode 12 and sends signals indicating the measured temperature to the CPU 24. Electric resistance of the thermistor 15 is varied by variation of the temperature around the themistor 15, so the CPU 24 can measure the temperature around the laser diode 12 by detecting variation of electric voltage inputted to the thermistor 15.

Control of the optical disk player 30 of the second embodiment will be explained with reference to a flow chart of FIG. 5.

Firstly, at a step S200, the CPU 24 reads data, e.g., the type of optical disk, recorded in an ATIP of the optical disk 10 by the optical puck-up 11, when the optical disk 10 is set to write data thereon. The data in the ATIP were wrote by a manufacturer before shipment.

The CPU 24 retrieves the recommended laser power P0 corresponding to the type of the optical disk 10 from the data table.

The CPU 24 executes the OPC test with the recommended laser power P0 and determines the initial laser power P1 for starting to write data on the optical disk 10.

At a step S202, the CPU 24 starts to write data with the laser power P1.

When writing data is started, the thermo sensor 15, e.g., a thermistor, real-timely detects or measures the present temperature around the laser diode 12 at a step S204. Then the thermo sensor 15 sends the signals indicating the measured temperature to the CPU 24. With this action, the CPU 24 can know the present temperature around the laser diode 12.

Then, at a step S206, if the CPU 24, which always monitors the light intensity of the reflected beam, judges that reduction of the light intensity of the reflected beam is greater than a prescribed value, the CPU 24 goes to a step S208. On the other hand, if the reduction of the light intensity is smaller than the prescribed value, the CPU 24 writes data with the present laser power.

At the step S208, the CPU 24 retrieves or selects the power correction value corresponding to the type of the optical disk 10 and the present temperature measured at the step S204 from the data table of the memory 26.

Namely, the CPU 24 selects the power correction value α1, 60 2 or 60 3, which corresponds to the type of the optical disk 10 and the measured present temperature around the laser diode 12, as the proper value. Note that, number of the power correction values is not limited to three. To precisely control the laser power, four or more power correction values may be prepared.

The CPU 24 controls the APC circuit 16 to add the selected correction value 60 1, α2 or α3 to the present laser power.

At a step S210, writing data is completed if all data have been written on the optical disk 10.

In the first and the second embodiments, data are written on the whole disk 10 by a constant linear velocity (CLV) manner. Further, data may be written by a zone CLV manner, in which linear velocity for writing data is accelerated by stages toward an outer part of the optical disk.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. An optical disk player, comprising:
a laser diode for irradiating a laser beam;
a photo sensor for detecting light intensity of a reflected beam, which is the laser beam reflected from an optical disk, while writing data on the optical disk;
means for controlling laser power of said laser diode by a running optimum power control manner, in which the laser power is adjusted, on the basis of the detected light intensity of the reflected beam while writing data on the optical disk, to optimum laser power; and
means for storing a plurality of power correction values for correcting the laser power for writing data to the optimum laser power as a data table, in which the power correction values have been determined on the basis of types of the optical disk and temperature,
wherein said control means retrieves the power correction value from said storing means and adds the retrieved power correction value to the present laser power of the laser diode in the case of increasing the laser power while writing data.

2. The optical disk player according to claim 1,
wherein said control means determines the temperature on the basis of a waveform of the light intensity of the reflected beam during the optimum power control action, retrieves the power correction value from said storing means on the basis of the type of the optical disk and the temperature, and varies the laser power of said laser diode by the retrieved power correction value when the laser power is adjusted.

3. The optical disk player according to claim 1,
further comprising a thermo sensor for detecting temperature around said laser diode,
wherein said control means retrieves the power correction value from said storing means on the basis of the type of the optical disk and the temperature detected by said thermo sensor, and varies the laser power of said laser diode by the retrieved power correction value.

4. The optical disk player according to claim 3,
wherein said thermo sensor is a thermistor.
